(19) United States
(12) Patent Application Publication
(10) Pub. No.: US 2018/0354093 A1
(43) Pub. Date: Dec. 13, 2018

(54) TOOL FOR STABILIZING A POSITION OF A SHAFT

(71) Applicant: Solar Turbines Incorporated, San Diego, CA (US)

(72) Inventors: Thomas Michael Luckett, San Diego, CA (US); Joshua Michael Rocklage, La Jolla, CA (US); Antonio Acuna, Chula Vista, CA (US); Jagadeesh Chandrasekar, San Diego, CA (US); Ashwinkumar Suresh Kashi, San Diego, CA (US)

(73) Assignee: Solar Turbines Incorporated, San Diego, CA (US)

(21) Appl. No.: 15/619,590

(22) Filed: Jun. 12, 2017

(51) Int. Cl. B24B 23/02; B25F 5/02; F16C 41/04

(52) U.S. Cl. CPC B24B 23/02; B25F 5/028; B25F 5/001; F16C 41/045; F16C 41/04

(57) ABSTRACT

A tool is provided for stabilizing a position of a shaft disposed within a casing and rotatably supported by a pair of bearings that are spaced-apart from one another and located within the casing. The tool includes an arcuately-shaped shoe that is located between the pair of bearings and releasably connected to the casing. The shoe has a concave surface defining a radius corresponding to a radius of the shaft. The shoe is resiliently biased away from the casing for facilitating the concave surface of the shoe to radially abut with a portion of an outer circumference of the shaft.

### TECHNICAL FIELD

The present disclosure relates to a tool for stabilizing a position of a shaft. More particularly, the present disclosure relates to a tool for stabilizing a position of a shaft during transportation of a machine in which the shaft is rotatably supported.

### BACKGROUND

Many machines are known to include a shaft for rotatively transmitting power from one component to another. For example, turbomachines such as gas turbine engines may include a turbine and a shaft for rotating the turbine. In many cases, these machines may need to be transported from one location to another. In such cases, the shaft, which would be typically supported on a pair of bearings within a housing of the machine, could be displaced from its initial position that is established during assembly of the machine. Such displacement of the shaft from its initial position during transportation of the machine could cause unintended forces to be radially applied to the bearings that support the shaft.

These forces may cause wear in the bearings. For example, an inner race or an outer race of the bearing could be subject to false brinelling with displacement of the shaft. Subsequently, a performance and service life of the bearings could deteriorate, in operation, if the shaft moves from its initial position. U.S. Pat. No. 6,098,263 (hereinafter referred to as ‘the '263 patent’) discloses that the rotatable shaft of a large machine could be blocked using a plurality of preloaded springs. These preloaded springs may be held by a collar member that is secured to the housing of the machine for preventing a roller bearing that supports the non-drive end of the shaft from being damaged during shipment of the machine.

As disclosed in the '263 patent, each of the springs is positioned in direct contact with the shaft. As each spring may offer little resistance to movement of the shaft from its initial position, many springs would need to be used to stabilize a position of the shaft, thus, requiring the collar member to support such springs while the collar member is annularly disposed about the shaft. This makes the collar member of the '263 patent bulky in construction. Therefore, the collar member may occupy a large amount of space that may not always be available in machines owing to various space constraints.

Hence, there is a need for a tool that is simple, compact and offers ease in use to provide adequate amount of resistance to the shaft in movement during transportation of the machine.

### SUMMARY OF THE DISCLOSURE

In an aspect of the present disclosure, a tool is provided for stabilizing a position of a shaft that could be disposed within a casing and rotatably supported by a pair of bearings. The bearings may be spaced-apart from one another within the casing. The tool includes an arcuately-shaped shoe that is located between the pair of bearings and releasably connected to the casing. The shoe has a concave surface defining a radius corresponding to a radius of the shaft. The shoe is resiliently biased away from the casing for facilitating the concave surface of the shoe to radially abut with a portion of an outer circumference of the shaft.

In another aspect of the present disclosure, a tool is provided for stabilizing a position of a shaft disposed within a casing and rotatably supported by a pair of bearings that are spaced-apart from one another and located within the casing. The tool includes a first plate, and a second plate that is spaced apart from and disposed parallel to the first plate.

The tool also includes a pair of primary fasteners slidably engaged with the first plate and extending through the first plate. The first plate defines a pair of holes to facilitate insertion of the pair of primary fasteners therethrough. An end of each primary fastener is adapted to threadably engage with the second plate. A pair of resilient members located between the first and second plates are disposed about the pair of primary fasteners.

Further, a stub extends from a side of the second plate disposed away from the first plate. An arcuately-shaped shoe is disposed at a free end of the stub and located away from the second plate. The shoe has a concave surface that defines a radius corresponding to a radius of the shaft so that the concave surface is adapted to abut with a portion of an outer circumference of the shaft. Furthermore, a pair of secondary fasteners releasably secures the first plate to the casing such that when the first plate is secured to the casing, a reaction force from the pair of resilient members resiliently biases the shoe radially against the outer circumference of the shaft. Additionally or optionally, the concave surface of the shoe could be affixed with a flexible material for abutting with the portion of the outer circumference of the shaft.

In an aspect of this disclosure, the pair of resilient members that are used to provide the reaction force to the shoe could include compression springs. As such, ends of the pair of resilient members are seated against the first and second plates such that the pair of resilient members undergo compression when the pair of secondary fasteners are fastened against the first plate for securing the first plate to the casing.

In an aspect of the present disclosure, the pair of primary fasteners include bolts. Each bolt has a head that is disposed about an axis and is configured to seat against the first plate. A shank extends from the head and is disposed about the axis. An end of each bolt includes a stepped portion that is adapted to threadably engage with the second plate. Correspondingly, the second plate includes a pair of threaded receptacles that are configured to facilitate the threadable engagement of the pair of primary fasteners with the second plate.

In another aspect of the present disclosure, each secondary fastener includes a grub screw threadably engaged with a threaded receptacle defined on the first plate, and a threaded nut that is adapted to seat against the first plate. The nut secures the first plate to the casing when the nut is fastened to the grub screw.

In yet another aspect of the present disclosure, embodiments disclosed herein are also directed to an engine having a casing, a shaft disposed within the casing and rotatably supported by a pair of bearings located within the casing, and employing the tool of the present disclosure to stabilize a position of the shaft within the casing in which the tool would be located between the pair of bearings. Such an engine may have an access door that is releasably connected to the casing to which the first plate may be releasably secured with the help of the secondary fasteners. The access door also defines a window that is configured to allow passage of the shoe therethrough.

Other features and aspects of this disclosure will be apparent from the following description and the accompanying drawings.

### BRIEF DESCRIPTION OF THE DRAWINGS

FIG. 1 is a side sectional view of a machine having a shaft and showing a tool that is used to stabilize a position of the shaft, in accordance with an embodiment of the present disclosure;

FIG. 2 is a front sectional view of the machine taken along sectional plane AA′ of FIG. 1 showing a pair of tools that are used to supportively stabilize the position of the shaft, in accordance with an embodiment of the present disclosure;

FIG. 3 is a perspective view of the tool showing arrangement of components therein;

FIG. 4 is a zoomed-in front sectional view of the machine showing the tool prior to assembly for use in stabilizing the shaft, in accordance with an embodiment of the present disclosure;

FIG. 5 is a zoomed-in front sectional view of the machine showing the tool in use for stabilizing the shaft, in accordance with an embodiment of the present disclosure; and

FIG. 6 is a flowchart depicting a method for stabilizing the position of the shaft, in accordance with an embodiment of the present disclosure.

### DETAILED DESCRIPTION

Reference numerals appearing in more than one figure indicate the same or corresponding parts in each of them. References to elements in the singular may also be construed to relate to the plural and vice-versa without limiting the scope of the disclosure to the exact number or type of such elements unless set forth explicitly in the appended claims.

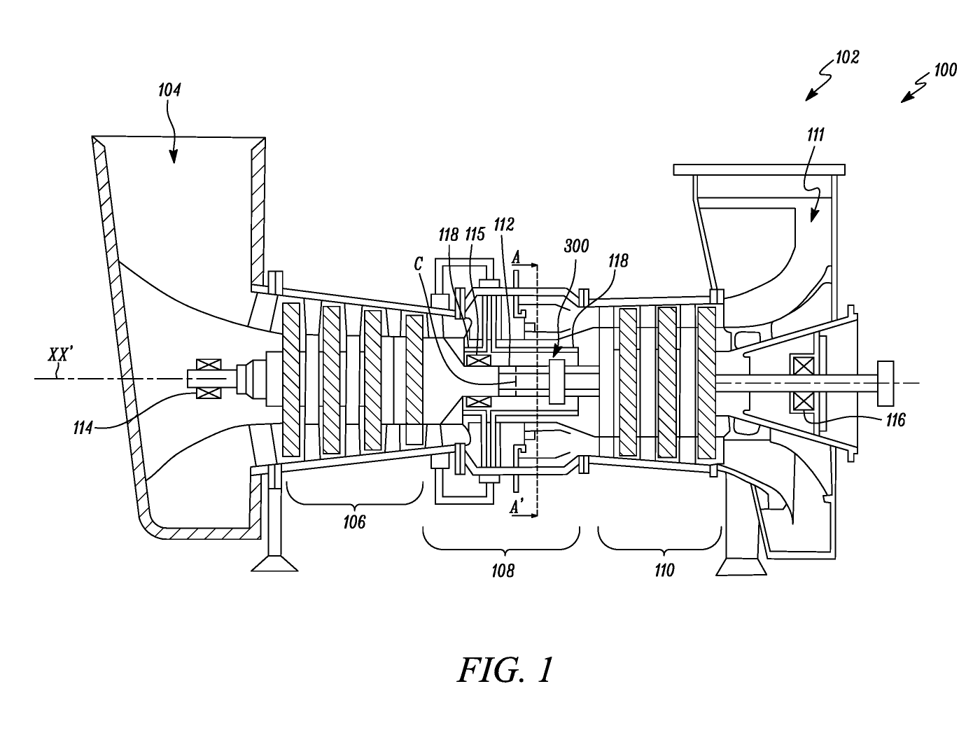

FIG. 1 illustrates a sectional view of a machine 100. As shown in FIG. 1, the machine 100 is embodied in the form of a gas turbine engine 102. The gas turbine engine 102 may be of any type. In one embodiment, the gas turbine engine 102 may be an industrial turbine engine including, but not limited to, an axial flow turbine used for power generation or driving mechanical assemblies. In other embodiments, the gas turbine engine 102 may be of a type that is typically used in jet propulsion systems. As shown in FIG. 1, the gas turbine engine 102 may embody an axial flow industrial turbine which may be used for power generation.

The gas turbine engine 102 may include, amongst a host of other systems, an inlet system 104, a compression system 106, a combustion system 108, a turbine system 110, and an exhaust system 111. The inlet system 104 may be configured to allow entry of air into the gas turbine engine 102 for supply to the compression system 106. The compression system 106 could compress air and operatively provide the compressed air to various components of the combustion system 108 and the turbine system 110. The compression system 106 may include a single stage compressor, or a multistage compressor. As shown in FIG. 1, the compression system 106 is embodied as a multistage rotary compressor.

The combustion system 108 would be configured to combust a mixture of fuel and air to produce mechanical energy that is transferred via a shaft 112 for operatively driving the turbine system 110. The exhaust system 111 could allow products of combustion to be released from the gas turbine engine 102.

The gas turbine engine 102 may be assembled at a manufacturing facility and then transported from the manufacturing facility to another location for use. The shaft 112, on which components from at least the compression system 106 and the turbine system 110 are mounted, may be supported by a pair of bearings 114, 116 as exemplarily shown in FIG. 1.

Each of these bearings 114, 116 is disposed about the shaft 112 and secured within a casing 118 of the gas turbine engine 102. Each of these bearings 114, 116 may include, for example, roller bearings, needle bearings, journal bearings or other types of bearings commonly known to persons skilled in the art. As shown in FIG. 1, the bearing 114 is located adjacent to the inlet system 104 while the bearing 116 is located adjacent to the exhaust system 111. Additionally, or optionally, another bearing 115 may be located between the compression system 106 and the combustion system 108 for added rotational support of the shaft 112 during an operation of the gas turbine engine 102.

Although three bearings 114, 115, and 116 are disclosed herein, it should be noted that a number of bearings used to rotatably support the shaft 112 disclosed herein is merely exemplary in nature and hence, non-limiting of this disclosure. Fewer or more bearings may be used depending on a configuration of the gas turbine engine 102 and other specific requirements of an application.

The present disclosure relates to a tool for stabilizing a position of the shaft 112 during transportation of the gas turbine engine 102 while the shaft 112 is positioned within the casing 118 and is rotatably supported by the bearings 114, 115, and 116. As shown in the illustrated embodiment of FIG. 1, this tool is located between the pair of bearings 115, 116 and is denoted by numeral ‘300’. However, in other embodiments, this tool 300 could be located between the pair of bearings 114, 115, or another tool, similar to the tool 300, could be additionally located between the bearings 114, 115 i.e., in addition to the tool 300 that is currently shown located between the bearings 115, 116 in FIG. 1. Therefore, it may be acknowledged by persons skilled in the art that a number of tools 300 used to stabilize the shaft 112 may vary to suit specific requirements of an application including, but not limited to, a length of the shaft, and/or a weight of the shaft. Further explanation to the tool 300 and its features will be made hereinafter.

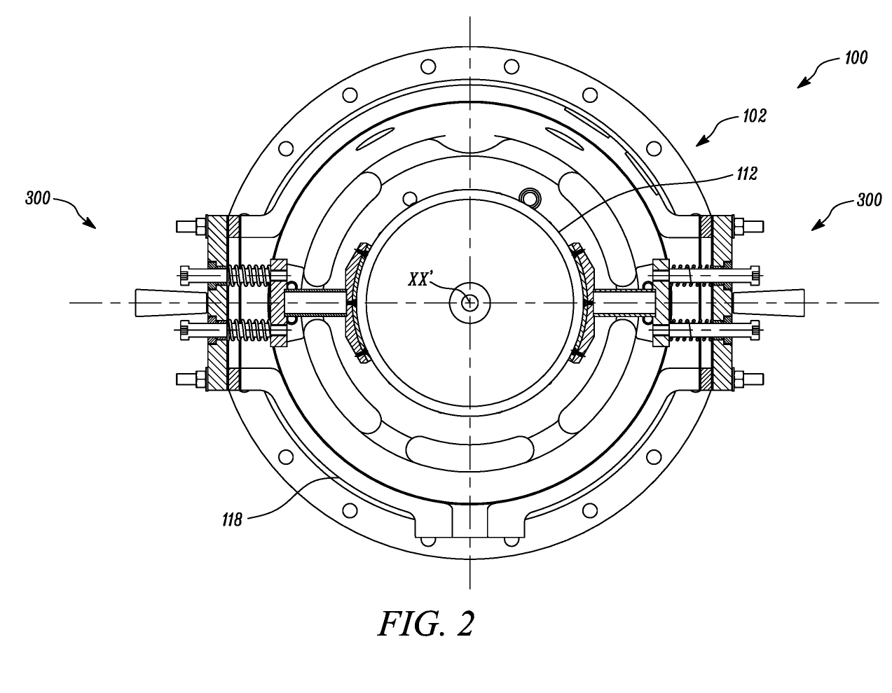

Referring to FIG. 2, the gas turbine engine 102 may employ a pair of tools 300 to co-operatively stabilize a position of the shaft 112 and help prevent the shaft 112 from moving out of its initial position that was established earlier in time, for instance, during assembly of the gas turbine engine 102. Although a pair of tools 300 is disclosed herein, it may be noted that the pair of tools is non-limiting of this disclosure. Rather, as disclosed earlier herein, the gas turbine engine 102 may employ fewer or more tools 300 for stabilizing a position of the shaft 112. Therefore, it will be acknowledged by persons skilled in the art that any number of tools 300, for example, one, two, three, or even four tools may be used to perform functions that are consistent with this disclosure.

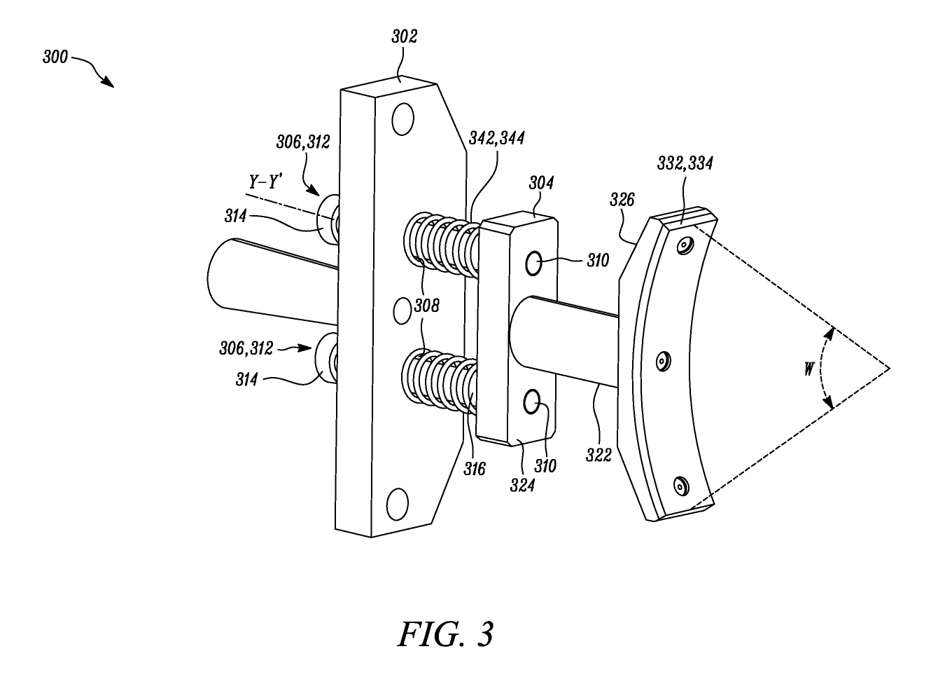

Referring to FIG. 3, the tool 300 includes a first plate 302, and a second plate 304 that is spaced apart from the first plate 302. In the illustrated embodiment of FIG. 3, the second plate 304 is disposed parallel to the first plate 302. However, in other embodiments, the first plate 302 could be disposed in a non-parallel configuration with respect to the second plate 304 depending on a cross-section of the casing 118 and a positioning of the shaft 112 in relation to a cross-section of the casing 118. For instance, as shown in FIG. 2, a cross-section of the casing 118 is circular and the casing 118 is concentrically disposed about an axis XX′ of the shaft 112 which allows for a parallel positioning of the first and second plates 302, 304 relative to one another.

With continued reference to FIG. 3, the tool 300 also includes a pair of primary fasteners 306 slidably engaged with the first plate 302 and extending through the first plate 302. The first plate 302 defines a pair of holes 308 to facilitate insertion of the pair of primary fasteners 306 with the first plate 302. An end 310 of each primary fastener 306 is adapted to threadably engage with the second plate 304.

In an embodiment as shown in FIGS. 3-5, the pair of primary fasteners 306 include bolts 312. Each bolt 312 has a head 314 that is disposed about an axis YY′ of the bolt 312. A shank 316 extends from the head 314 and is disposed about the same axis YY′. The end 310 of each bolt 312 includes a stepped portion 318 that is adapted to threadably engage with the second plate 304. The second plate 304 includes a pair of threaded receptacles 320 that are configured to facilitate the threadable engagement of the pair of primary fasteners 306 with the second plate 304.

Further, a stub 322 extends from a side 324 of the second plate 304 and is disposed away from the first plate 302. An arcuately-shaped shoe 326 is located at a free end 328 of the stub 322. The shoe 326 has a concave surface 330 that is disposed away from the second plate 304. The concave surface 330 of the shoe 326 defines a radius R1 corresponding to a radius R2 of the shaft 112 so that the concave surface 330 is adapted to abut with a portion of an outer circumference C of the shaft 112.

In the illustrated embodiment of FIGS. 2-5, the radius R1 of the concave surface 330 is concentrically larger than the radius R2 of the shaft 112. In this embodiment, the concave surface 330 could, additionally or optionally, be affixed with a flexible material 332 for abutting with a portion of the outer circumference C of the shaft 112. This flexible material 332 may include a pad 334 of pre-determined thickness T that is formed from materials including, but not limited to, Teflon® (also known as Polytetrafluoroethylene [PTFE]), or other types of polymers known to persons skilled in the art.

Furthermore, a pair of secondary fasteners 336 are provided to releasably secure the first plate 302 to the casing 118. In an embodiment as shown in FIGS. 2-5, each secondary fastener 336 includes a grub screw 338 that is received within a corresponding aperture 350 defined on the first plate 302 and is threadably engaged to the casing 118. The secondary fastener 336 also includes a threaded nut 340 that is adapted to seat against the first plate 302. The nut 340 secures the first plate 302 to the casing 118 when the nut 340 is fastened to the grub screw 338.

Moreover, a pair of resilient members 342 are located between the first and second plates 302, 304 and disposed about the pair of primary fasteners 306. In an embodiment as shown in FIGS. 2-5, the pair of resilient members 342 could include compression springs 344. Moreover, ends 346, 348 of the compression springs 344 are seated against the first and second plates 302, 304 respectively.

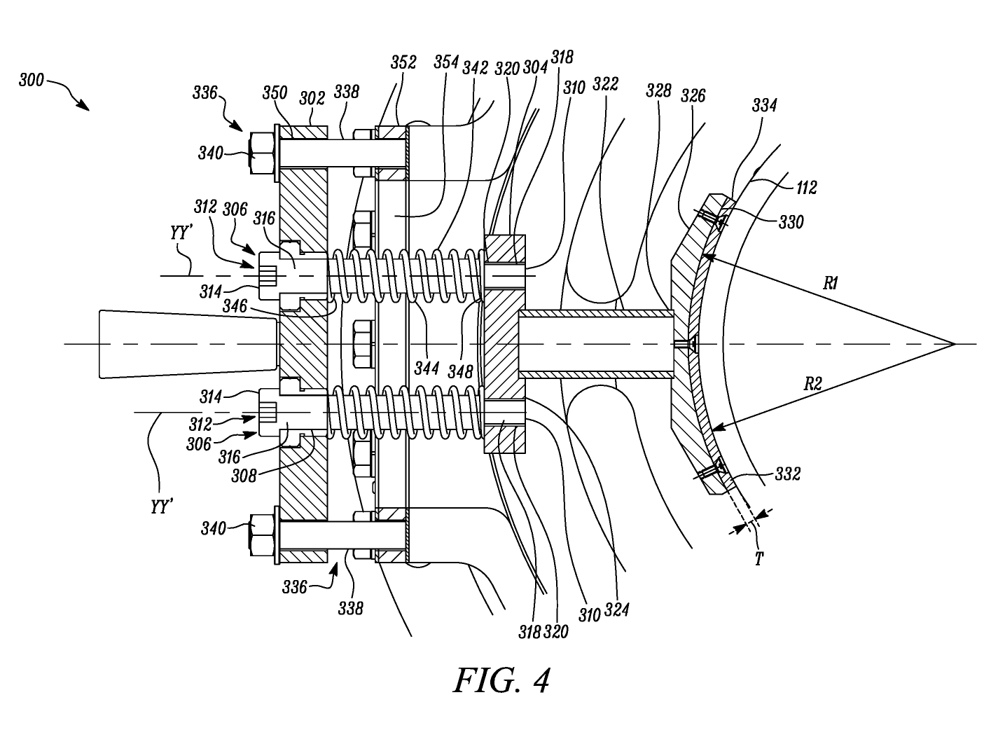

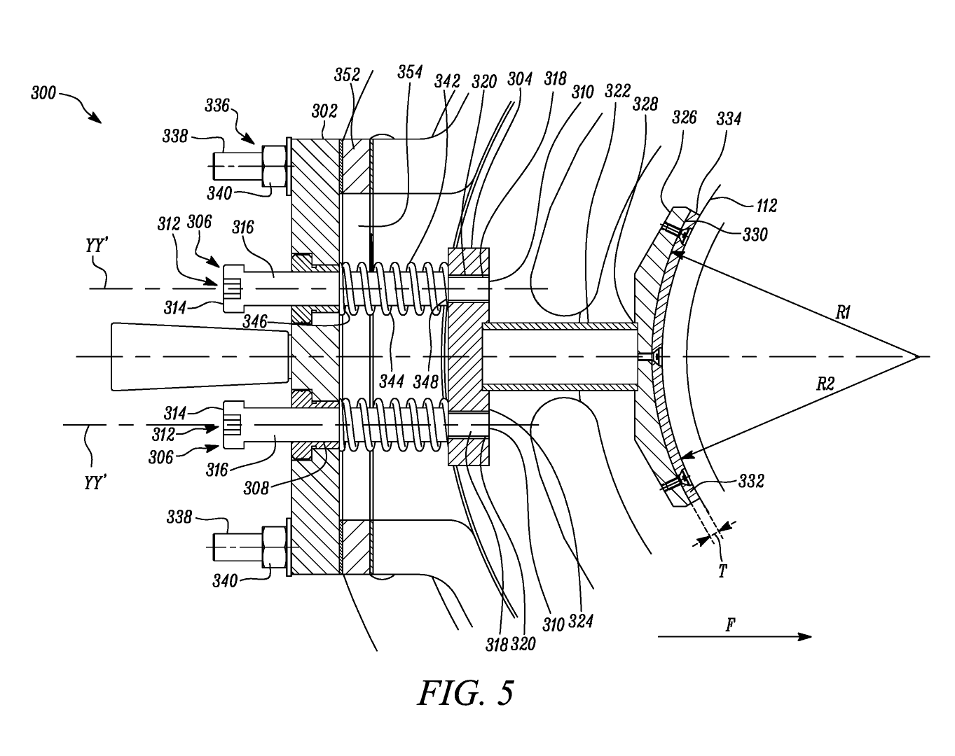

Referring to FIG. 4, the tool 300 is shown prior to assembly with the casing 118 of the gas turbine engine 102 in which the secondary fasteners 336 are shown prior to being fastened against the first plate 302. Referring to FIG. 5, the secondary fasteners 336 are shown after being fastened against the first plate 302 such that the tool 300 is assembled to the casing 118 of the gas turbine engine 102. Referring to FIGS. 4-5, the pair of resilient members 342 are adapted to undergo compression when the pair of secondary fasteners 336 are fastened against the first plate 302 tfor securing the first plate 302 to the casing 118. Moreover, as shown in FIG. 5, when the first plate 302 is secured to the casing 118, a reaction force from the pair of resilient members 342 resiliently biases the shoe 326 radially against the outer circumference C of the shaft 112. A direction of the reaction force is indicated by direction arrow ‘F’. An amount of biasing force offered by the resilient members 342 would depend on an amount of stiffness associated with the compression springs 344. As such, the springs 344 would be configured to exhibit a pre-determined amount of stiffness that would be selected before-hand depending on an amount of mass associated with the shaft 112.

In a further embodiment as shown in FIGS. 2 and 4-5, the gas turbine engine 102 may, additionally or optionally, have an access door 352 that is releasably connected to the casing 118. The first plate 302 disclosed herein may be releasably secured to the access door 352, that is, in lieu of a direct securement of the first plate 302 with the casing 118. The releasable securement of the first plate 302 to the access door 352 could be established with the help of the secondary fasteners 336 disclosed herein.

The access door 352 disclosed herein would also define a window 354 that is configured to allow passage of the shoe 326 therethrough. The window 354 would be sized and shaped to correspond with a size and shape of the shoe 326 so as to allow passage of the shoe 326 through the window 354 during assembly or removal of the tool 300 from the gas turbine engine 102. It has been contemplated that another access door (not shown) similar to the access door 352 disclosed herein would be provided with the machine 100, in this case, the gas turbine engine 102. The other access door could be similar in size and shape to that of the access door 352 disclosed herein, however with the only exception that the other access door would not be configured to define a window, such as the window 354, therein. The other access door may be secured to the casing 118 upon removal of the tool 300 from the gas turbine engine 102 so that this other access door would close an opening (see FIG. 2 and FIGS. 4-5) defined by the casing 118, for instance, during operation of the gas turbine engine 102.

It may be noted that although embodiments of the present disclosure have been explained in conjunction with the gas turbine engine 102 disclosed herein, the gas turbine engine 102 is non-limiting of this disclosure. Persons skilled in the art will appreciate that the tool 300 can be used on other types of machines having a shaft 112 included therein and in which the shaft of the machine requires resistance in movement from an initial position that is established during assembly of the machine so that such a machine can be transported from one location to another without causing any wear to bearings, for instance, bearings 114, 115, and 116 that are provided to support a rotation of the shaft 112, during operation of the machine.

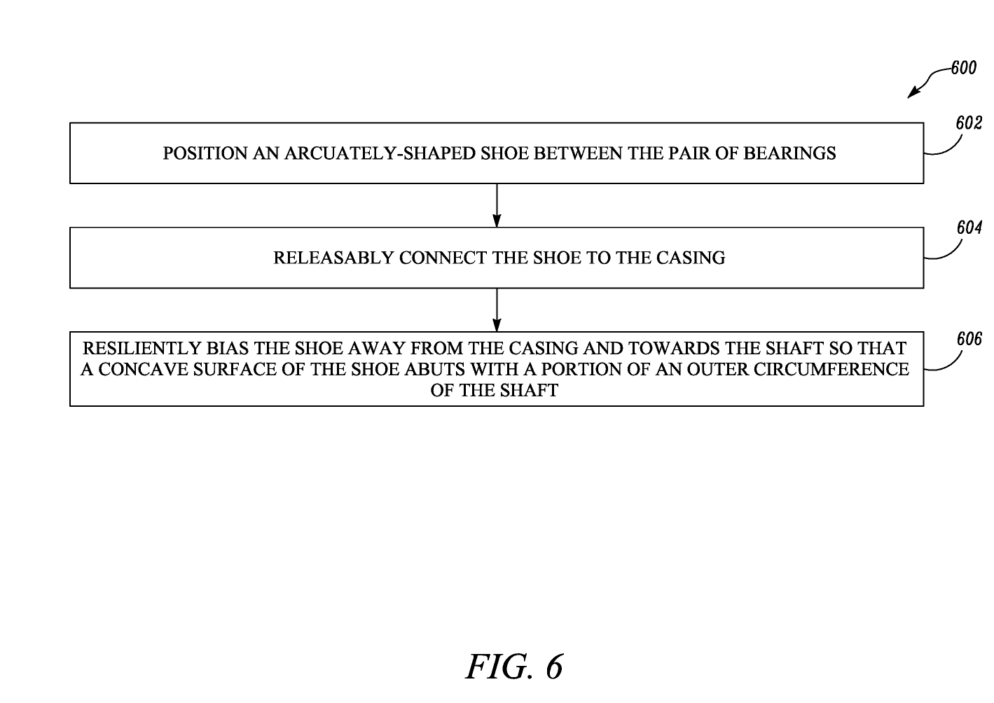

FIG. 6 is a flowchart depicting a method 600 for stabilizing the position of the shaft 112. At step 602, the method 600 includes positioning an arcuately-shaped shoe 326 between the pair of bearings 115, 116. At step 604, the method 600 further includes releasably connecting the shoe 326 to the casing 118. At step 606, the method 600 further includes resiliently biasing the shoe 326 away from the casing 118 and towards the shaft 112 for facilitating the concave surface 330 of the shoe 326 to abut with a portion of the outer circumference C of the shaft 112. As disclosed earlier herein, the shoe 326 could be resiliently biased away from the casing 118 and towards the shaft 112 with the help of resilient members 342, which in an embodiment herein, is disclosed as including the pair of compression springs 344.

In embodiments of this disclosure, it has been disclosed that the concave surface 330 of the shoe 326 is configured to define a radius R1 corresponding to a radius R2 of the shaft 112. However, in embodiments herein, it should also be noted that an angular width W of the shoe 326 as shown in FIG. 3 may be varied depending on the radius of the shaft encountered from one application to another. The angular width W of the shoe 326 may be large for a shaft having a large radius R2. For example, the angular width W of the shoe 326 may be about 45 degrees. In another example, the angular width W of the shoe 326 may be about 60 degrees. In another example, the angular width W of the shoe 326 may be about 90 degrees. In yet another example, the angular width W of the shoe 326 may be about 180 degrees.

Various embodiments disclosed herein are to be taken in the illustrative and explanatory sense, and should in no way be construed as limiting of the present disclosure. All joinder references (e.g., attached, affixed, coupled, engaged, meshed, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to or over another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for use and implementation in stabilizing a position of a shaft in a machine that is to be transported from one location to another. With use of the tool disclosed herein, manufacturers can ensure that little or no wear occurs to the bearings when the machine is being transported as the tool disclosed herein is configured to resist any movement in the shaft during transport.

Moreover, the tool of the present disclosure is simple and cost-effective to construct as compared to previously known designs of conventional stabilization systems or fixtures. Further, the tool disclosed herein is less-bulky in construction as compared to conventional stabilization systems or fixtures. Owing to the compact design and size of the tool disclosed herein, the tool of the present disclosure may allow manufacturers to stabilize a shaft in a machine where space constraints would otherwise not permit fitment of conventional stabilization systems or fixtures.

Also, the tool of the present disclosure is configured to mitigate various detrimental effects such as false brinelling that would otherwise occur to the bearings supporting a shaft of a given machine. Therefore, it will be appreciated that use of the tool disclosed herein can help manufacturers of machines to save time, costs, and effort that would be incurred towards repair and/or replacement of the bearings if the position of a shaft in a machine has not been stabilized before transportation of the machine.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A tool for stabilizing a position of a shaft disposed within a casing and rotatably supported by a pair of bearings spaced-apart from one another and located within the casing, the tool comprising:
a first plate;
a second plate spaced apart from the first plate and disposed parallel to the first plate;
a pair of primary fasteners received within the first plate and extending through the first plate, an end of each primary fastener adapted to threadably engage with the second plate;
a pair of resilient members located between the first and second plates and disposed about the pair of primary fasteners;
a stub extending from a side of the second plate disposed away from the first plate;
an arcuately-shaped shoe disposed at a free end of the stub and located away from the second plate, the shoe having a concave surface defining a radius corresponding to a radius of the shaft such that the concave surface is adapted to abut with a portion of an outer circumference of the shaft; and
a pair of secondary fasteners configured to releasably secure the first plate to the casing such that when secured, a reaction force from the pair of resilient members is configured to resiliently bias the shoe radially against the outer circumference of the shaft.

2. The tool of claim 1, wherein the first plate defines a pair of holes to facilitate insertion of the pair of primary fasteners therethrough.

3. The tool of claim 1, wherein the pair of resilient members include compression springs.

4. The tool of claim 1, wherein ends of the pair of resilient members are seated against the first and second plates such that the pair of resilient members are adapted to undergo compression when the pair of secondary fasteners are fastened against the first plate.

5. The tool of claim 1, wherein the pair of primary fasteners include bolts having:
a head disposed about an axis;
a shank extending from the head and disposed about the axis; and
wherein an end of each bolt includes a stepped end adapted to threadably engage with the second plate.

6. The tool of claim 1, wherein the second plate includes a pair of threaded receptacles configured to facilitate the threadable engagement of the pair of primary fasteners with the second plate.

7. The tool of claim 1, wherein each secondary fastener includes:
a grub screw threadably engaged with a threaded receptacle defined on the first plate; and
a threaded nut that is adapted to seat against the first plate and secure the first plate to the casing when the nut is fastened to the grub screw.

8. The tool of claim 1, wherein the concave surface of the shoe is affixed with a flexible material, the flexible material configured to abut with the portion of the outer circumference of the shaft.

9. An engine having:
a casing;
a shaft disposed within the casing and rotatably supported by a pair of bearings located within the casing; and
employing the tool of claim 1 to stabilize a position of the shaft within the casing, wherein the tool is located between the pair of bearings.

10. The engine of claim 9, wherein the engine is a gas turbine engine.

11. The engine of claim 9 further including an access door releasably connected to the casing, wherein the first plate is releasably secured to the access door with the help of the pair of secondary fasteners.

12. The engine of claim 11, wherein the access door defines a window configured to allow passage of the shoe therethrough.

13. A tool for stabilizing a position of a shaft disposed within a casing and rotatably supported by a pair of bearings spaced-apart from one another and located within the casing, the tool comprising:
an arcuately-shaped shoe located between the pair of bearings and releasably connected to the casing, the shoe having a concave surface defining a radius corresponding to a radius of the shaft, wherein the shoe is resiliently biased away from the casing for facilitating the concave surface of the shoe to radially abut with a portion of an outer circumference of the shaft.

14. The tool of claim 13 further comprising:
a first plate located exterior to the casing;
a second plate spaced apart from the first plate and disposed parallel to the first plate;
a pair of primary fasteners slidably engaged with the first plate and extending through the first plate, an end of each primary fastener adapted to threadably engage with the second plate;
a pair of resilient members located between the first and second plates and disposed about the pair of primary fasteners;
a stub extending from a side of the second plate disposed away from the first plate, wherein a free end of the stub is configured to support the shoe thereon; and
a pair of secondary fasteners configured to releasably secure the first plate to the casing such that when secured, a reaction force from the pair of resilient members is configured to resiliently bias the shoe radially against the outer circumference of the shaft.

15. The tool of claim 14, wherein the concave surface of the shoe is affixed with a flexible material, the flexible material configured to abut with the portion of the outer circumference of the shaft.

16. The tool of claim 14, wherein the second plate is located within the casing.

17. The tool of claim 14, wherein the pair of resilient members include compression springs.

18. A method for stabilizing a position of a shaft disposed within a casing and rotatably supported by a pair of bearings spaced-apart from one another and located within the casing, the method comprising:
positioning an arcuately-shaped shoe between the pair of bearings;
releasably connecting the shoe to the casing;
resiliently biasing the shoe away from the casing and towards the shaft for facilitating a concave surface of the shoe to abut with a portion of an outer circumference of the shaft.

19. The method of claim 18, wherein the concave surface of the shoe is configured to define a radius corresponding to a radius of the shaft.

20. The method of claim 18, wherein the shoe is resiliently biased away from the casing and towards the shaft with the help of compression springs.
